(19) United States
(12) Patent Application Publication
(10) Pub. No.: US 2009/0210404 A1
(43) Pub. Date: Aug. 20, 2009

(54) DATABASE SEARCH CONTROL

(76) Inventor: Kelce S. Wilson, Murphy, TX (US)

Correspondence Address: KELCE WILSON, 1205 TERRACE MILL DRIVE, MURPHY, TX, 75094, US

(21) Appl. No.: 12/031,701

(22) Filed: Feb. 14, 2008

(51) Int. Cl. G06F 17/30

(52) U.S. Cl. 707/5; 707/E17.108

(57) ABSTRACT

Identifying a search engine user's preference for handling quotations, using easily remembered variations for enclosing a quote, simplifies the user interface. An example is enclosing the quote in either single or double quotation marks to indicate search options for the quote. A method of controlling a database search comprises receiving a search string; identifying, within the search string, a pair of phrase indicia such as quotation marks; identifying, between the pair of indicia, a quote string; matching the pair of phrase indicia to one of a plurality of pairs of indicia, wherein first and second ones of the plurality indicate an exact quote search and a modified quote search, respectively; and identifying, responsive to the matching, a request for an exact quote search or a modified quote search. The modified quote search may be a spell corrected search, a word stemmed search, an alternate spelling search, or a translated search.

### TECHNICAL FIELD

The present invention relates generally to database searching, and more particularly to controlling database search options.

### BACKGROUND

Database searching is a common function of computer usage, and takes a wide variety of forms. For example a computer system user may search the internet for a web page or a document; the contents of a single document or computer file, such as a word processing, database, spreadsheet or portable document format (PDF) file; or a collection of documents, such as a collection of issued patents, trade publications, or court decisions. Database searching may be accomplished at a website, within a locally-executing computer application, or within a local computer network, such as an intranet. Typically, a user enters a desired search string into a search string entry window, to specify search criteria, such as specific text. The search engine may display search results as a list, or may move a cursor position or otherwise display and highlight a portion of a document containing a search result.

Examples of searching a collection of documents include searching Westlaw and LexisNexis for court decisions. An example of searching the internet includes using a search engine provider, such as Google, which provides a search string entry window to a user through an internet connection. U.S. Pat. No. 6,285,999 to Page, titled METHOD OF NODE RANKING IN A LINKED DATABASE, and U.S. Pat. No. 7,269,587 to Page, titled SCORING DOCUMENTS IN A LINKED DATABASE provide examples of internet search technology, and are hereby incorporated by reference. Examples of searching a document and a collection of documents include using a find window, which is a search string entry window associated with a PDF reader. In some situations, a find window may be moved off of the main document display window, however, it remains associated with the computer application, enabling searches in a displayed document and/or other documents accessible using that application.

Many search engines provide advanced search options. For example, Westlaw and LexisNexis allow word stemming upon entry of a word-stem indicia, such as an exclamation point. Using word stemming, a search for “invent” is expanded to include searches for “invented”, “inventor” and “invention”. Thus, by entering “invent!” into a search string entry window on a website, a user can search for multiple words without having to enter them individually. While some search engines that do not use word stemming will return search results on base words which have different prefixes and suffixes, the primary value of word stemming occurs when a base word occurs in the middle of a quotation. Thus, “an invent! conference” will include searches for “an inventor's conference” and “an invention conference”. Some implementations of word stemming can include both prefix and suffix additions and changes. Typically, search engines offering word stemming require explicit identification of the words for which word stemming is requested, by using a single character adjacent to the word.

Some search engines provide user options to apply word stemming automatically, without requiring an indicia within the string. The option is controlled outside the search string entry window, in an options selection window. However, there are often warnings against having the word stemming option turned on when searching for quotes of multi-word phrases. For example, a warning might state “Phrase queries with word stemming on might not return expected results. For optimal results, turn word stemming off while searching for a phrase.” To comply with this suggestion, a user find the options window or page, go to it, find the specific option selection point, turn the option off, and the return to the search string entry window, prior to performing the search. This involves several additional steps.

Internet search engines and document search functions similarly offer advanced search options. The search options, however, are typically selectable using menus outside a search string entry window. For example, Google's website offers hyperlinks adjacent to the search string entry window, which enable a user to select from among available search options such as specific languages. Further, Google's search engine provides a spell check function which, if it detects a spelling error, prompts a user to conduct a spell corrected search with a spell corrected search string. This prompting, however, requires a second search, whose results are not intermingled with the original search string, and is provided only after the first search is completed. This is because the Google search engine input interpreter has no way of determining whether a user wishes to search for a particular odd spelling within a quote, or else is willing to have the search terms spell corrected or otherwise changed prior to conducting a search.

A search engine user may wish to search for a specific quoted phrase, spelled exactly as entered in a search string entry window, without modification, but in other situations may wish the search engine to automatically modify a quoted phrase, for example by performing spell checking or word stemming. Current search engines require one of the following: (1) use of a special word stemming indicia adjacent to a specific word to be stemmed, which must be remembered and is not intuitive, (2) several additional steps of locating and detouring through an options selection window, prior to performing the search, and/or (3) the user to select a second search after the first search is performed, using suggested changes.

### SUMMARY OF THE INVENTION

Identifying a search engine user's preferences for handling quotations prior to performing the search, using intuitive, easily remembered variations for enclosing the quote, simplifies the user interface and makes searching more efficient. Allowing for the using of multiple different quote enclosures, with different significance, enables a search engine input interpreter to determine, among other things, whether a user wishes to search for a particular odd spelling within a quote, or else is willing to have the search terms spell corrected or permit other modifications prior to conducting a search.

An embodiment of a method of controlling a search of a database may comprise receiving a search string; identifying, within the search string, a pair of phrase indicia; identifying, between the pair of phrase indicia, a quote string; matching the pair of phrase indicia to one of a plurality of pairs of phrase indicia, wherein a first one of the plurality of pairs indicates an exact quote search and a second one of the plurality of pairs indicates a modified quote search; and identifying, responsive to the matching, a request for an exact quote search or a modified quote search. The plurality of pairs of phrase indicia may comprises a pair of single quotation marks and a pair of double quotation marks and/or a pair of brackets. Other characters and combinations may also be used, and the opening and closing characters may be different. The search engine may be provided across an internet or intranet connection or be local to the user's computer. The database to be searched may be the internet, a collection of documents, or contents of a portion of a single document. The modified quote search may comprises a spell corrected search, a word stemmed search, an alternate spelling search, a translated search, or any combination. A modification option selection window or page may still be used, so that, if a modified quote search is selected, the options selected in the modification option selection window or page are triggered, but if an exact quote search is selected, then any modification options that are indicated as active on the modification option selection window or page are not used. The quote string may be a single word or a multi-word phrase.

An embodiment of a search system may comprise a processor; a data storage system coupled to the processor; a database at least partially contained within the data storage system; a search module contained within the data storage system; a search string entry module coupled to the search module; a search string modification module coupled to the search module and the search string entry module; a search string interpretation module coupled to the search string entry module and the search string modification module, and configured to: identify, within a search string received through the search string entry module, a pair of phrase indicia; identify, between the pair of phrase indicia, a quote string; control the search string modification module to selectively modify the quote string, responsive to the identified pair of phrase indicia. An embodiment may further comprise a modification option module coupled to the string modification module.

### BRIEF DESCRIPTION OF THE DRAWINGS

For a more complete understanding of the present invention, reference is now made to the following descriptions taken in conjunction with the accompanying drawings, in which:

FIG. 1 illustrates a flow diagram for a method of controlling a search of a database; and

FIG. 2 illustrates a system for controlling a search of a database.

### DETAILED DESCRIPTION OF THE INVENTION

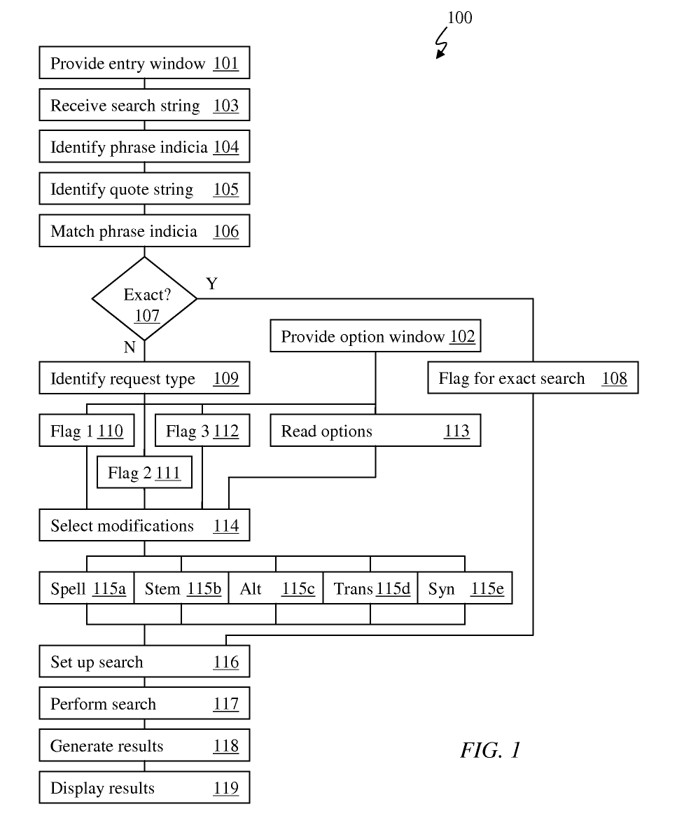

FIG. 1 illustrates a flow diagram of a method 100, which is an embodiment of a method for controlling a search of a database. In block 101, a search engine interface system provides a search string entry window to a user, for example on a user's computer display. The user can then type or paste a search string into the window. The search string entry window may be on a page of a visited website or a remote computer on a local network, such as an intranet or local area network (LAN), or may be a find window in a computer application, such as a word processor, document viewer, spreadsheet program, or document catalog. The computer application may be running locally or on a remote server system, and may either display a single document in which the user wishes to search for the string, or may provide search capabilities for strings within documents of a certain type located within a selected section of a file storage system. Advanced document search options, such as excluding certain sections of a document or documents, or weighting different document sections or document types can continue to be supported with various embodiments.

In block 103, the search engine receives the contents of the search string entry window as a requested search string. In block 104, the presence of a pair of phrase indicia within the search string is identified, which indicates the starting and stopping point of a quote string. Quote strings may be multi-word phrases or single word phrases, and may be nested, such that one quote is within another, and a search string may contain multiple quote strings. In the English language, phrase indicia for quotations are commonly single or double quotation marks, with the quote string being the words and characters between the starting and stopping indicia. However, it should be understood that other phrase indicia may be used, including two adjacent single quotation marks “ ”, a round bracket ( ), a square bracket [ ], a curly bracket { }, an angle bracket < >, a slash mark / \, and a dash - - - . A common name for a round bracket is a parenthesis, and dashes may be various widths. Other characters appearing on a keyboard, such as asterisks *, vertical lines |, exclamation points !, plus signs +, or others may also be used to offset and/or otherwise demark a quote string. The different types of mark characters may be used alone, or in combination with another mark at each end of the quote string. As used herein an accent mark ', which is often found on the top left key of a query keyboard having a top row of numbers and punctuation marks, and apostrophes may be used as forms of a quotation mark. It should be noted that a pair of phrase indicia need not have the same starting and stopping mark type. For example, a quote may be demarked by an opening double quotation mark, and be terminated by a different mark, such as a single quotation mark. In the event that different types of opening and closing marks are used, pairings can be determined by analyzing nesting, i.e. starting with an innermost quote and identifying pairings by moving outward. Quotation marks may be either curved or straight, depending on the font used when entering the search string.

In block 105, a quote string between a pair of phrase indicia within the search string is identified. A search string may contain more than one quote string, which may or may not be nested, and may be enclosed within differing pairs of phrase indicia, which indicate user requests for differing treatment of the quote strings by the search engine. The following description will discuss the operation of method 100 as applied to a single search string, although it should be understood that if a search string contains multiple quote strings, an embodiment of a method for controlling a search of a database can perform a duplicate of the disclosed operation, between blocks 104 and 116, for each quote string. In block 106, the pair of phrase indicia is matched to one of a plurality of pairs of phrase indicia, such as pairs of the mark types previously described. One of the pluralities of pairs, for example double quotation marks, indicates an exact quote search, whereas another one of the plurality of pairs indicates that a user requested a modified quote search.

A modified quote search may be a spell corrected search, a word stemmed search, an alternate spelling search, a translated search, a synonym search, or a combination modification search, which uses combinations of different modification types. A spell corrected search may include a search in which both the original input word and a word passed through a spell checking and correction algorithm are combined with a Boolean OR and the search is performed on both words. Alternatively, the original input word could be discarded and only the spell corrected word searched. This is different from current search engines, which search the original input first, and then suggest a second search for a spell corrected word. This approach prevents a user from seeing documents containing properly spelling and common misspellings in the same search results, which the user may actually desire in some situations. Additionally, some internet based companies have found value in reducing the number of mouse clicks needed by a visitor to their website. Combining the properly spelled and misspelled words together in the same search can reduce, by at least one, the number of mouse clicks needed over the prior art, possibly rendering the search a one-click search.

A word stemmed search includes various forms of a base word, including versions with prefixes, suffixes, and other changes, such as possessives, plurals, and noun versus verb changes. Word stemming is known in the art, and is currently used in search engines, but with marks appended to the word to be stemmed, rather than allowing for a pair of characters to enclose a phrase inside of which all words associated with a word stemmed search are automatically modified prior to searching.

An alternate spelling search is related to a word stemmed search, although many simple word stem searches do not include changes that are internal to a word. Examples of alternate spellings include “Tom”, which in an alternate spelling search may become “Thomas” and “Tommy”, and “Bob”, which may become “Bobby”, “Robert”, “Rob” or “Robby”. Further, there are differences between American and British spelling of some words within the larger definition of the English language, including “organization” versus “organisation”. Another common word with multiple spellings is “canceled” versus “cancelled”. Some advanced word stemming engines may also include generating some or all of these alternate spellings. The quality of a word stemmed search and an alternate spelling search will depend largely on the completeness of any databases used by a search string modification module in relating various alternative spellings and word forms. Using an alternative spelling search, searches results for certain historical figures, such as “Abe Lincoln” can then be intermingled with search results for “Abraham Lincoln”, but only if the searcher desires this.

Some search engines automatically include alternate spelling searches for certain words, such as proper names, even when the names are placed within quotes. However, a user is unable to disable the feature from within the search string entry window. Thus, if a user is looking only for a document known to contain a particular version of a name, the search results from a search engine which automatically include alternate spelling searches will return unwanted, superfluous results.

A translated search translates the quote phrase to a set of predetermined languages, and then performs a search using both the original language and the translated set, or only the translated set. Selection of the language or languages may need to be accomplished using a set using a translation or modification option selection window, since there may be a large number of options. Option selection could include whether the search results are displayed in the native language of the result or are translated to the language used when typing in the search string. Such an option selection could be done either with a modification option selection window or by using one pair of phrase indicia to request one-directional translation only but a different pair of phrase indicia to request translation in both directions, i.e. both of the quote string and the search results are translated. One advantage of using a pair of phrase indicia to demark a quote string for a translated search is that a search on a relatively long string may be performed, with only a subset of words translated. This option is not available with prior art systems that allow translated searches only on either the entire search string, or no part of the string at all, and opens the possibility of finding documents containing sections with potentially mixed-language usage within the same document.

A synonym search uses a thesaurus database to use synonyms of an entered word or words, for example by adding synonyms linked with a Boolean OR. A synonym search for multi-word phrases can use synonyms on a word-for-word basis or on an idiomatic phrase level. For example, “head north” would be synonymous with “go north” on an idiomatic level, but could be “ruler north” or “skull north” on a word-for-word synonym basis. The exercise of the idiomatic or word-for-word option could be done by using different pairs of phrase indicia for different types of synonym searches, or could be set in a modification option selection window.

Search options can become complex, so advanced options for selecting among detailed variations within the different classes of searches may require the use of an advanced search modification option selection window. For example, a modification option selection window could allow specification of a maximum number of synonyms to be used and selection between idiomatic versus word-for-word options. It should be understood that other modification options, in addition to those described herein, are also usable with the invention. It should be further understood that fewer than all described modification options may be used, and that alternative pairs of phrase indicia, in addition to those described, may be used.

In decision block 107, if the pair of phrase indicia is identified as matching a request for an exact quote search, method 100 moves to block 108, in which a logical flag is set for the quote string to identify an exact search, and then moves to block 116 to set up the search for a search module which actually performs the search. Some embodiments will use an identification of an exact quote search request to override any interpretation of perceived quote strings nested within the exact quote string.

In decision block 107, if the pair of phrase indicia is identified as not matching a request for an exact quote search but rather a modified quote search, method 100 moves to block 109, in which a logical flag is set for the quote string to identify the type of requested search in one of blocks 110-112. Some embodiments will use a single pair of phrase indicia to indicate that a modified search is requested by the user, and then the specific modifications, such as those described previously, are selectively invoked when reading modification options in block 113. The modification options are set when a modification option selection window is presented to the user in block 102, for example via a link on a webpage or a pull-down menu, outside the search string entry window. The modification options may be preset to a default, common set, and are modifiable by optional user access of the modification option selection window. Although three search types are indicated by boxes 110-112, is should be understood that a greater or lesser quantity of search types may be used.

Some embodiments use a different pair of phrase indicia to identify a user request for various modification options. In such an embodiment, a first pair could indicate an exact quote search, a second pair could indicates a first modified quote search, and a third pair could indicate a second modified quote search different from the first modified quote search. Other pairs and search types are possible. For example, a pair of double quotation marks could indicate an exact quote search, a pair of single quotation marks could indicate a spell corrected search, a pair of angle brackets could indicate a word stemmed search, a pair of round brackets could indicate an alternative spelling search, a pair of curly brackets could indicate a translated search, and a pair of square brackets could indicate a synonym search

Search modifications are selected in block 114. In some embodiments, different modifications may be used simultaneously in a single search, for example spell correction and translation. Either both options could be turned on through a modification option selection window, or the pairs of phrase indicia could be nested, for example placing a quote string between single quotes and then between curly brackets could trigger spell correction and translation. In some embodiments, the order of the nesting of different indicia determines the order of modification. In some embodiments, the order of the nesting of different indicia is ignored, and modifications are performed in a predetermined order, such as spell correction prior to word stemming, which is prior to translation.

The search preparation is then performed in block 116, which selects the various modifications, if any, for inclusion in the search. In some embodiments, the setup links the various modifications using Boolean ORs in order to capture all of the variations. This removes the burden from the user of manually entering synonyms, multiple alternative spellings and various word stemming options, and also having to wait until the first search is run in order to search a second time for a spell corrected version.

In block 117, the database is searched accordance with the user's request, as interpreted according to the entered phrase indicia. The database may be the internet, portions of the contents of a single document, or a collection of documents. Additionally, a webcrawler could create a database of documents, storing indications of their contents for use in a search, along with the document uniform resource locator (URL). The database may thus comprise locations of linked documents on a computer network. In block 118, the search results are generated or compiled, which may include translation, based on the user's request. In block 119, the results are displayed for the user, such as with a directory listing or by displaying the portion of the document matching search results. In some embodiments, a specific word or character in the document will be highlighted.

The possibility of demarking a quote phrase within a search string for a synonym search enables a search engine to offer a powerful search option on a selective basis for only specified words within the search string, which can minimize the chances of search result overload. By keeping the demarcation simple and intuitive, the option is available to even untrained users, who do not need to keep a handy reference card for triggering all the various search options, which may be difficult to memorize and easy to forget. The availability of a modified search, such as a synonym search, by using special phrase indicia allows the search engine to offer powerful search options from within the while preserving simple, exact quote searching.

For example, a search engine could interpret a search string such that any phrase enclosed by double quotes is an exact phrase search, words not enclosed by any marks are linked by Boolean ORs or ANDs based on default search criteria options, words enclosed within single quotation marks are to be spell corrected, and words enclosed by brackets or surrounded by asterisks are to have synonyms included in the search.

All of this power and flexibility is available to the user within the search string entry window, while remaining easy to remember, due to the intuitive interface. Further, a user can control multiple options with a single search command, mixing desired options within a single search string, such as to allow spell correction on one phrase, but not on another, and translating one word, but not on others. This is in contrast to systems which turn options on or off for entire search strings, and do not allow selective use of powerful options within a search string. In-line triggering or rejection of search-expanding options preserving a user's ability to exploit the power of a search engine, while retaining the ability to easily limit searches to exact phrases in order to avoid receiving extraneous, unwanted results.

Double quotation marks are more intuitively associated with an exact quote, whereas single quotation marks are more intuitively associated with a search in which modifications are allowable. This is because the double quotation mark seems more like an emphasis on a quote, because the mark is repeated. A substitute for a double quotation mark, in the event that a user's keyboard lacks the required character key, is two adjacent single quotation marks adjacent, with no other words between. For example, certain multi-tap keyboards only provide single quotation marks in order to preserve key count. However, it should be understood that a different pair of phase indicia could be used to indicate an exact quote search request and that double quotation marks could be used to indicate a modified quote search.

A preferred intuitive selection for a synonym search could be resolved between curly braces, which somewhat resemble the letter “S”, and square brackets, because they are commonly used when changing words in quotations. A preferred intuitive selection for a stemmed search could be resolved between parenthesis, which are used in mathematics to denote an open set of numbers, and angle brackets, because they somewhat resemble the letter “S”, and square brackets, because they are commonly used when changing words in quotations. In some embodiments, different opening and closing marks have significance. For example, an opening angle bracket and a closing double quotation mark could mean prefix stemming, but no suffix stemming. The pairing could then be determined by nesting, rather than mark equivalence.

Some embodiments may be combined with existing prior art to enhance search engine functionality. For example, a prior art embodiment of a computer implemented method of scoring a plurality of linked documents comprises: obtaining a plurality of documents, at least some of the documents being linked documents, at least some of the documents being linking documents, and at least some of the documents being both linked documents and linking documents, each of the linked documents being pointed to by a link in one or more of the linking documents; assigning a score to each of the linked documents based on scores of the one or more linking documents and processing the linked documents according to their scores. Improvement is possible to the prior art system, for example by identifying, between a pair of phrase indicia within a received search string, a quote string; and identifying, based on the pair of phrase indicia, a request for an exact quote search or a modified quote search, wherein the processing comprises identifying documents in the plurality of linked documents in accordance with the request.

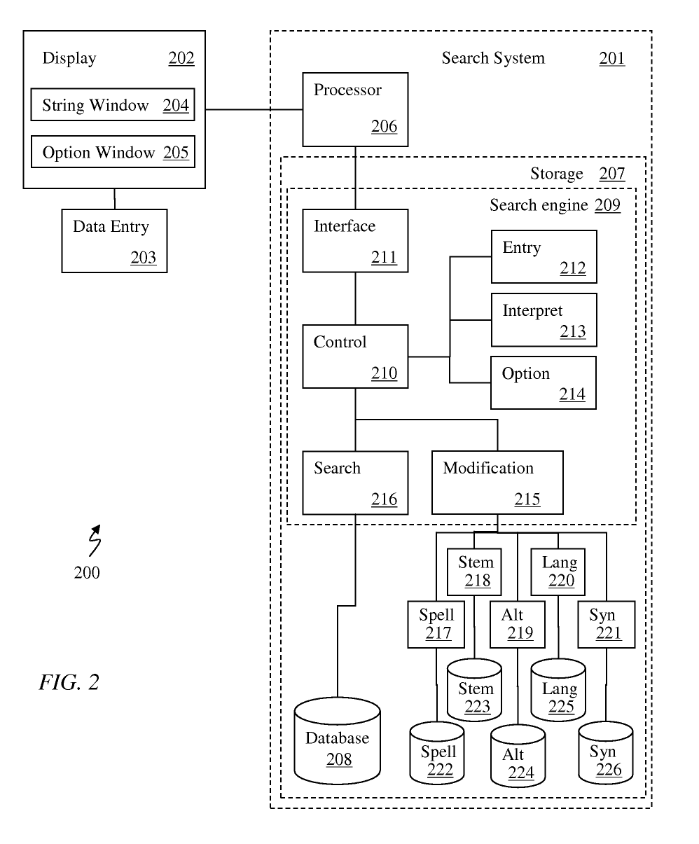

FIG. 2 illustrates an embodiment of a system 200 for controlling a search of a database in accordance with method 100. System 200 comprises a search system 201, which is coupled to a user display 202 and data entry system 203. User display 202 may be a computer monitor or a display window of a PDA or a communication device, and data entry system 203 may comprise a keyboard and/or a mouse. User display 202 and data entry system 203 may be co-located with search system 201 or may be remote. For example, search system 201 may comprise a desktop personal computer (PC), so that display 202 is the computer monitor coupled to search system 201 and data entry system 203 is a keyboard and/or mouse coupled to search system 201. Alternatively, search system 201 may be a remote internet search engine, so that display 202 is a display local to a user, which is coupled to search system 201 through an intervening computing device. Display 202 displays a search string entry window 204 and a modification option selection window 205, into which a user enters data using data entry system 203. In some embodiments, modification option selection window 205 will not appear on display 202 until after a user requests access, such as, for example, clicking on a hyperlink or a menu option using data entry system 203.

Search system 201 comprises a processor 206, which may be a central processing unit (CPU), or may comprise a set of high-powered computing systems. Search system 201 also comprises a data storage system 207, which is coupled to processor 206, and which contains at least a portion of database 208. In some embodiments, data storage system 207 comprises a computer readable medium, and includes a mixture of volatile and non-volatile memory, such as firmware and/or one or more digital media drives (DMDs). In some embodiments, data storage system 207 comprises at least a portion of the internet. Data storage system 207 also comprises at least a portion of search engine 209, which is coupled to database 208.

Search engine 209 comprises a control module 210, an interface module 211, a search string entry module 212, a search string interpretation module 213, a modification option module 214, a search string modification module 215, and a search module 216. In the illustrated embodiment, interface module 211 is shown as coupled to each of search string entry module 212, search string interpretation module 213, modification option module 214, search string modification module 215, and search module 216, and thus all of modules 211-216 are coupled together. Search module 216 is also illustrated as coupled to database 208. However, it should be understood that other coupling arrangements are also possible.

In the illustrated embodiment controller 210 controls the searching of database 208 in accordance with a user's search requests, and interfaces with the user's display 202 and data entry system 203 through interface module 211 and processor 206. In some embodiments, interface module 211 receives data input from the user, such as a search string input into search string entry window 204 and optionally modification option selections input into modification option selection window 205. Search string entry window 204 may comprise a text box suitable for receiving typed text and text pasted from a computer clipboard. Modification option selection window 205 may comprise a set of check boxes associated with search options, and can be put into a checked state or an unchecked state by mouse clicks. In some embodiments, interface module 211 also outputs search results generated by search module 216 to enable the display of the search results on user display 202.

In some embodiments, search string entry module 212 generates the search string entry window 212 and controls input parameter, possibly providing event handlers for mouse clicks and keyboard entries. Search string interpretation module 213 receives a search string through interface module 211 and parses the search string to identify, within the search string, one or more pairs of phrase indicia. Search string interpretation module 213 then identifies, between the pairs of phrase indicia, corresponding quote strings, and matches each pair of phrase indicia to one of a plurality of preselected pairs of phrase indicia. This enables search string interpretation module 213 to identify which type or types of quote search the user is requesting. In some embodiments, interface module 211 search string entry module 212, and search string interpretation module 213 and others of modules 210-216 may comprise a module or modules of a computer program, which is embodied on a computer-readable medium portion of storage system 207, and is executable by a processor, for example processor 206. However parts of search engine 209 may be implemented in firmware, such as a field programmable gate array (FPGA) and/or an application specific integrated circuit (ASIC).

In some embodiments, modification option module 214 stores modification option sets, which correspond to various user search modification requests, and are indexed to the plurality of preselected pairs of phrase indicia. The option sets may be set to initial default values, but may be changeable by user input via modification option selection window 205 by using data entry system 203. Modification option module 214 may thus further control display of modification option selection window 205 on user display 202, through interface module 211. If multiple quote strings are detected, modification option module 214 correlates a modification option set with each one. In some embodiments, modification option module 214 may detect and remove duplicate user requests, and/or change the order of requests, if pairs of phrase indicia are nested. For example, if nested pairs of indicia correspond to a request for a spell corrected search within a request for an exact quote search, the request for a spell corrected search will be deleted, and the pair of phrase indicia corresponding to the request for a spell corrected search will be treated as part of an exact quote, rather than a user request. As another example, if nested pairs of indicia correspond to a request for a translated search within a request for a spell corrected search, spell correction will be performed first, since attempted translation of a misspelled is not productive, and a translation result should not require spell checking. In some embodiments however, the order of modifications, indicated by nesting of pairs of indicia, can be preserved. In some embodiments, a request for a modified search will be determined to be a combination modification search, for which multiple modifications are indicated without nesting pairs of phrase indicia, and the order of multiple modifications will follow a predetermined order.

Search string modification module 215 performs the requested modification or modifications, and sends a compiled search request, comprising the modifications and optionally the original input search string, to search module 216. Search module 216 searches database 208 in accordance with the user's request, generates search results, and sends an indication to controller 210, which controls the displaying of the search results on user display 202 through interface module 211. Modification module 215 is coupled to a spelling module 217, a word stemming module 218, an alternate spelling module 219, a language module 220, and a synonym module 211, which perform spell correction, word stemming, alternate spelling generation, translation, and synonym generation, respectively. Spelling module 217, word stemming module 218, alternate spelling module 219, language module 220, and synonym module 211 are coupled to a spelling database 217, a word stemming database 218, an alternate spelling database 219, a language database 220, and a synonym database 211, respectively. Spell checking, word stemming, alternate spelling identification, language translation, and synonym-finding are known in the art. In some embodiments, some or all of spelling module 217, word stemming module 218, alternate spelling module 219, language module 220, synonym module 211, spelling database 217, word stemming database 218, alternate spelling database 219, language database 220, and synonym database 211 are contained within search engine 209. However, and of the modules 217-221 and databases 222-226 may be external to search engine 209. Based on a translation modification request, search module 216 may route some search requests through language module 220 to enable translation of the search results prior to their display.

Although the present invention and its advantages have been described above, it should be understood that various changes, substitutions and alterations can be made herein without departing from the spirit and scope of the invention as defined by the appended claims. Moreover, the scope of the present application is not intended to be limited to the particular embodiments described in the specification.

What is claimed is:

1. A method of controlling a search of a database, the method comprising:
receiving a search string;
identifying, within the search string, a pair of phrase indicia;
identifying, between the pair of phrase indicia, a quote string;
matching the pair of phrase indicia to one of a plurality of pairs of phrase indicia, wherein a first one of the plurality of pairs indicates an exact quote search and a second one of the plurality of pairs indicates a modified quote search; and
identifying, responsive to the matching, a request for an exact quote search or a modified quote search.

2. The method of claim 1 further comprising:
searching the database in accordance with the request.

3. The method of claim 2 further comprising:
generating search results from the searching; and
displaying the search results.

4. The method of claim 1 wherein identifying a request comprises setting a logic flag.

5. The method of claim 1 wherein the plurality of pairs of phrase indicia comprises a pair of single quotation marks and a pair of double quotation marks.

6. The method of claim 1 wherein the plurality of pairs of phrase indicia comprises a pair of brackets.

7. The method of claim 1 wherein the second one of the plurality of pairs comprises a first and a second indicia, and wherein the first and second indicia are each selected from the group consisting of:
a double quotation mark, a single quotation mark, two adjacent single quotation marks, a round bracket, a square bracket, a curly bracket, an angle bracket, a slash mark, and a dash.

8. The method of claim 7 wherein first and second indicia of the second one of the plurality are different.

9. The method of claim 1 further comprising:
providing a search string entry window to a user through an internet connection, wherein receiving a search string comprises receiving contents of the search string entry window.

10. The method of claim 1 further comprising:
providing a search string entry window to a user, wherein the search string entry window is associated with a computer application displaying a document to the user, wherein
receiving a search string comprises receiving contents of the search string entry window, and wherein the search of a database comprises a search of at least a portion of contents of the document.

11. The method of claim 1 wherein the database comprises locations of linked documents on a computer network.

12. The method of claim 1 wherein the modified quote search comprises a search selected from the group consisting of:
a spell corrected search, a word stemmed search, an alternate spelling search, a translated search, and a synonym search.

13. The method of claim 1 further comprising:
receiving, from outside a search string entry window, modification option selections specifying a manner of generating the modified quote search.

14. The method of claim 1 wherein the matching the pair of phrase indicia to one of the plurality of pairs of phrase indicia comprises matching the pair of phrase indicia to one of at least three pairs of phrase indicia, wherein the first one of the plurality of pairs indicates an exact quote search, the second one of the plurality of pairs indicates a first modified quote search, and a third one of the plurality of pairs indicates a second modified quote search different from the first modified quote search.

15. The method of claim 1 wherein the quote string comprises a single word.

16. A computer implemented method of scoring a plurality of linked documents, comprising: obtaining a plurality of documents, at least some of the documents being linked documents, at least some of the documents being linking documents, and at least some of the documents being both linked documents and linking documents, each of the linked documents being pointed to by a link in one or more of the linking documents; assigning a score to each of the linked documents based on scores of the one or more linking documents and processing the linked documents according to their scores;
wherein the improvement comprises:
identifying, between a pair of phrase indicia within a received search string, a quote string; and
identifying, based on the pair of phrase indicia, a request for an exact quote search or a modified quote search, wherein the processing comprises identifying documents in the plurality of linked documents in accordance with the request.

17. The method of claim 16, wherein the processing includes:
displaying links to the linked documents as a directory listing.

18. The method of claim 16 wherein the modified quote search comprises a synonym search.

19. The method of claim 16 further comprising:
receiving, from outside a search string entry window, modification option selections specifying a manner of generating the modified quote search.

20. A search system comprising:
a processor;
a data storage system coupled to the processor;
a database at least partially contained within the data storage system;
a search module contained within the data storage system;
a search string entry module coupled to the search module;
a search string modification module coupled to the search module and the search string entry module; and
a search string interpretation module coupled to the search string entry module and the search string modification module, and configured to:
identify, within a search string received through the search string entry module, a pair of phrase indicia;
identify, between the pair of phrase indicia, a quote string; and
control the search string modification module to selectively modify the quote string, responsive to the identified pair of phrase indicia.

21. The system of claim 20 further comprising:
a modification option module coupled to the string modification module, and configured to control setting of modification options.
